(19) United States
(12) Patent Application Publication
(10) Pub. No.: US 2009/0043462 A1
(43) Pub. Date: Feb. 12, 2009

(54) Worksite zone mapping and collision avoidance system

(76) Inventors: Kenneth Lee Stratton, Dunlap, IL (US); G. Derrick Darby, Dunwoody, GA (US); Jamie Shults, Peoria, IL (US); Robert Briggs, Cary, NC (US); Augusto Opdenbosch, Roswell, GA (US); Juan Carlos Santamaria, Suwanee, GA (US); Fu Pei Yuet, Peoria, IL (US); Jean-Jacques Clar, Dunlap, IL (US)

Correspondence Address: CATERPILLAR/FINNEGAN, HENDERSON, L.L.P., 901 New York Avenue, NW, WASHINGTON, DC, 20001-4413, US

(21) Appl. No.: 12/213,934

(22) Filed: Jun. 26, 2008

Related U.S. Application Data
(60) Provisional application No. 60/929,503, filed on Jun. 29, 2007.
(60) Provisional application No. 60/929,504, filed on Jun. 29, 2007.

(51) Int. Cl. G08G 1/16; G06F 19/00

(52) U.S. Cl. 701/50; 701/301

(57) ABSTRACT

A worksite mapping system is disclosed. The worksite mapping system has a receiving module configured to receive a position and a characteristic of an object at a worksite, a positioning device configured to determine a position of a mobile machine at the worksite, and a controller in communication with the receiving module and the positioning device. The controller is configured to generate an electronic map of the worksite, and an electronic representation of the object on the electronic map based on the received position. The controller is further configured to generate at least one boundary zone around the object based on the received characteristic, and an electronic representation of the mobile machine on the electronic map based on the determined position. The controller is further configured to initiate a collision avoidance strategy in response to a mobile machine entering the at least one boundary zone.

This application claims the benefit of U.S. Provisional Application No. 60/929,503, filed Jun. 29, 2007, and U.S. Provisional Application No. 60/929,504, filed Jun. 29, 2007.

### TECHNICAL FIELD

The present disclosure is directed to a machine control system, including a worksite mapping system, and more particularly, to a system for mapping zones about stationary objects and mobile machines at a worksite to control mobile machines to avoid collisions with stationary objects and other mobile machines at a common worksite.

### BACKGROUND

Mobile machines such as, for example, haul trucks, excavators, motor graders, backhoes, water trucks, and other large equipment are utilized at a common worksite to accomplish a variety of tasks. At these worksites, because of the size of these machines, lack of visibility, slow response time, and difficulty of operation, operators must be keenly aware of their surroundings. Specifically, each operator must be aware of the location of stationary objects at the worksite, road conditions, facilities, and other mobile machines in the same vicinity. Based on the speed of a particular machine, and its size and response profile, the operator of the machine must respond differently to each encountered obstacle in order to avoid collision and damage to the machine, the objects at the worksite, and other mobile machines. In some situations, there may be insufficient warning for the operator to adequately maneuver the machine away from damaging encounters.

One way to help minimize the likelihood of damaging encounters or the severity of unavoidable encounters is disclosed in US Patent Application Publication No. 2006/0293856 (the '856 publication) by Foessel et al., published on Dec. 28, 2006. Specifically, the '856 publication discloses a sensing system that collects position data associated with one or more obstacles within a certain range of a vehicle. A former establishes an occupancy grid based on the collected position data. A motion monitoring module determines a reaction distance and a deceleration distance associated with the vehicle. A safety guidance module establishes a safety zone about the vehicle based on the occupancy grid, the determined reaction distance, and the deceleration distance. A vehicle controller autonomously controls vehicular speed or warns an operator to control vehicular speed consistent with the safety zone.

Although the sensing system of the '856 publication may help minimize the likelihood of damaging encounters by sensing obstacles in a zone about a moving vehicle and warning an operator or autonomously slowing the vehicle based on near obstacles, it may be expensive and limited. That is, because every vehicle is required to have a sensing system, the cost of each vehicle may increase substantially. For fleet operations, this increased cost may be prohibitive. Further, because the sensing system of the '856 publication only takes into account characteristics of the vehicle, the protection provided by the system may be inadequate for some obstacles or other mobile machines in the path of the vehicle.

The mapping and machine control system of the present disclosure is directed to one or more improvements in the existing technology.

### SUMMARY OF THE INVENTION

One aspect of the present disclosure is directed to a machine control system, including a receiving module configured to receive a position and a characteristic of an object at a worksite, a positioning device configured to determine a position of a mobile machine at the worksite, and a controller in communication with the receiving module and the positioning device. The controller is configured to generate an electronic map of the worksite, and an electronic representation of the object on the electronic map based on the received position. The controller is further configured to generate at least one boundary zone around the object based on the received characteristic, and an electronic representation of the mobile machine on the electronic map based on the determined position.

Another aspect of the present disclosure is directed to a method of avoiding collisions of a mobile machine with other objects at a common worksite, including receiving a position and a characteristic of an object at a worksite, and a position of a mobile machine at the worksite. The method also includes generating an electronic map, and an electronic representation of the object on the electronic map based on the received position. The method further includes generating at least one boundary zone around the object based on the received characteristic, and generating an electronic representation of the mobile machine on the electronic map based on the determined position.

Yet another aspect of the present disclosure is directed to a machine control system. The machine control system includes a receiving module configured to receive a map of a worksite, the map having an electronic representation of an object at the worksite and at least one boundary zone positioned around the object. The machine control system further includes a controller in communication with the receiving module, the controller being configured to initiate a collision avoidance strategy in response to a mobile machine entering the at least one boundary zone.

And yet another aspect of the present disclosure is directed to a method of avoiding collisions of a mobile machine with other objects at a common worksite. The method includes receiving a map of the worksite, the map having an electronic representation of an object at the worksite and at least one boundary zone positioned around the object. The method also includes initiating a collision avoidance strategy in response to a mobile machine entering the at least one boundary zone.

### BRIEF DESCRIPTION OF THE DRAWINGS

FIG. 1 is a diagrammatic illustration of an exemplary disclosed machine operating at a worksite;

FIG. 2 is a schematic and diagrammatic illustration of an exemplary disclosed control system and remote communication system for use with the machine of FIG. 1; and

FIG. 3 is a flowchart depicting an exemplary method of operating the remote communication system and control system of FIG. 2.

### DETAILED DESCRIPTION

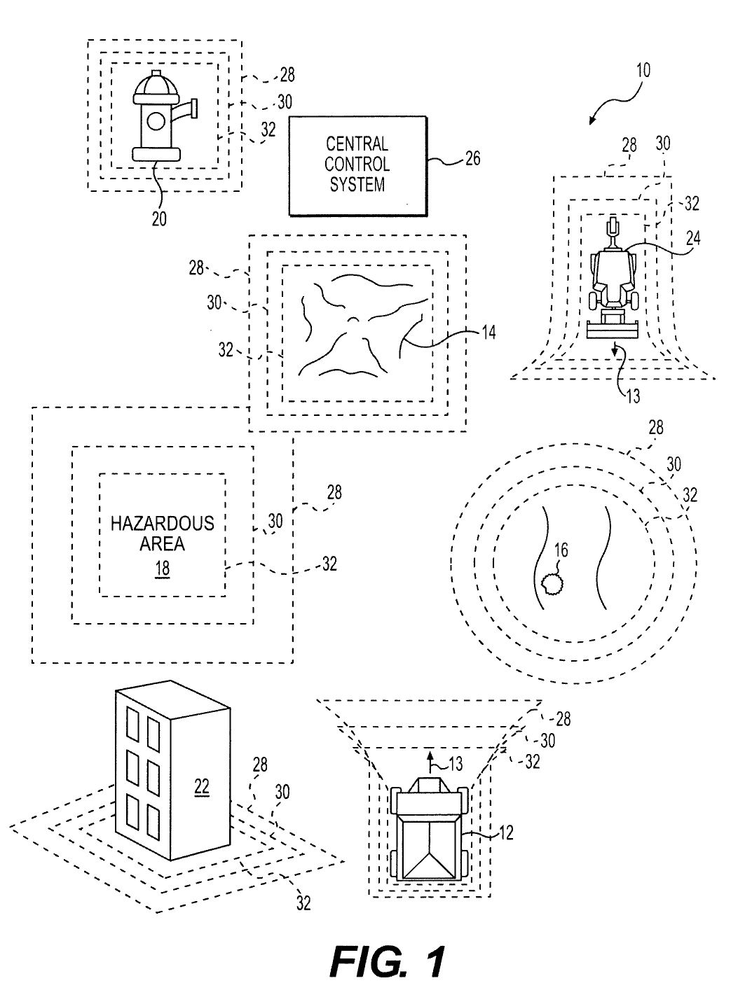

FIG. 1 illustrates an exemplary worksite 10 with a mobile machine 12 performing a predetermined task. Worksite 10 may include, for example, a mine site, a landfill, a quarry, a construction site, a road worksite, or any other type of worksite. The predetermined task may be associated with any work activity appropriate at worksite 10, and may require machine 12 to generally traverse worksite 10.

Machine 12 may embody any type of driven machine that may be used at worksite 10. For example, machine 12 may embody a haul truck, an excavator, a motor grader, a backhoe, or a water truck. Machine 12 may generally be moved about worksite 10 by a power source such as a motor or an engine. Machine 12 may have a direction represented in FIG. 1 by an arrow 13, a velocity represented by a length of arrow 13, and an acceleration (not represented). Although not shown, the movement of machine 12 may be at least partially determined by an acceleration control, a braking control, and a direction control. The acceleration control of machine 12 may include, for example, an acceleration pedal and/or a deceleration pedal connected to change operation of the power source and/or an associated transmission to accelerate or decelerate machine 12. The braking control of machine 12 may include, for example, a brake pedal connected to a braking element to slow or stop machine 12. The direction control of machine 12 may include, for example, a steering wheel, a joystick, or any other direction control known in the art connected to change the direction of machine 12. It is contemplated that machine 12 may include any number of other components and features such as, for example, a traction device, an operator cabin, a work tool, or any other component or feature known in the art. It is also contemplated that machine 12 may embody an autonomous machine configured to autonomously traverse worksite 10 or a manned machine configured to traverse worksite 10 under the control of an operator.

As machine 12 traverses worksite 10, it may encounter any number of obstacles that make movement of machine 12 difficult, hazardous, or even impossible. The obstacles at worksite 10 may include, for example, a natural obstacle 14 such as a cliff, a body of water, a tree, or a high grade; and a road condition 16 such as a pothole, loose gravel, or a dynamic weather related condition such as, for example, ice or mud. The obstacles at worksite 10 may further include a hazardous area 18 such as a fuel site, a waste site, or an explosive operation; a stationary inanimate object 20 such as a fire hydrant, a parking lot, a gas/electric line, a tank, or a generator; a facility 22 such as a storage facility or a trailer/portable building; and/or other vehicles 24. It is contemplated that vehicle 24 may include any type of mobile vehicle that may traverse worksite 10, and may be autonomously or manually controlled. It is further contemplated that machine 12 may be regarded as an obstacle with respect to the movement of vehicle 24.

In order to facilitate collision avoidance of machine 12 with the obstacles at worksite 10, a central control system 26 may generate a terrain map of worksite 10. Central control system 26 may generally include components that cooperate to receive signals from the obstacles and machine 12, generate the terrain map, and transmit signals to the obstacles and machine 12. The terrain map may include, for example, work surface data describing ground elevation and/or ground material composition, consistency, etc., at various locations at worksite 10. The terrain map may further include the locations of machine 12 and the obstacles at worksite 10. The locations may be represented by, for example, site coordinates. Central control system 26 may generate the terrain map and store it in a memory as, for example, a 2-dimensional or 3-dimensional grid, or in any other manner known in the art. Thus, the terrain map, including the obstacles at worksite 10 and machine 12, may be represented as data in the memory of central control system 26. Further, the data representing the obstacles and machine 12 may include site coordinates corresponding to their locations on the grid. It is contemplated that the terrain map may be embodied as a database accessible by central control system 26.

Central control system 26 may receive and store data representative of the terrain at worksite 10 in any manner known in the art. For example, worksite 10 may be surveyed and the resulting data may be input directly to central control system 26 through a user interface including, for example, a keyboard and a computer monitor. In another example, the data may be downloaded into the memory of central control system 26 from an existing map. In yet another example, the data may be downloaded into the memory of central control system 26 from another source such as, for example, satellite imaging. Central control system 26 may update the terrain map in real-time, including showing changes made to the terrain of worksite 10 as a work operation (e.g., excavation) takes place, and movements of machine 12 and vehicle 24 about worksite 10. For example, prior to excavation, the terrain of worksite 10 may be defined in site coordinates. Upon or during completion of excavation, such as, for example, digging a foundation of predetermined dimensions, the terrain map of worksite 10 may be redefined to match the new dimensions of the actual terrain. It is contemplated that central control system 26 may wirelessly deliver the data representing all or a portion of the terrain map to machine 12.

The terrain map may also include artificial e-fences about each obstacle at worksite 10. That is, central control system 26 may associate at least one artificial e-fence with each of natural obstacle 14, road condition 16, hazardous area 18, stationary inanimate object 20, facility 22, and vehicle 24. It is contemplated that each artificial e-fence may be 2-dimensional or 3-dimensional, and may have a number of operational parameters including, for example, a number of zones, and a particular shape and/or size.

The artificial e-fences about each obstacle may include any number of zones. In an exemplary embodiment, central control system 26 may define three types of e-fence zones. More specifically, central control system 26 may define a warning e-fence zone 28, an avoidance e-fence zone 30, and a stopping e-fence zone 32. Each of e-fence zones 28, 30, 32 may be associated with a recommended course of action should machine 12 enter the zone of that type. More specifically, e-fence zones 28, 30, 32 may represent varying degrees of collision avoidance strategies associated with the trespassing thereof by machine 12. That is, the severity of the collision avoidance strategy of stopping e-fence zone 32 may be greater than that of avoidance e-fence zone 30, which may further be greater than that of warning e-fence zone 28.

In one example, the number of e-fence zones may be dependent on the type of obstacle. For example, a pothole may cause minor damage to machine 12, while a cliff may cause more severe damage to machine 12 and/or personal injury to an operator. Thus, the number of e-fence zones defined about each obstacle may be at least partially based on a criticality of a collision of machine 12 with that particular obstacle. More specifically, the number of e-fence zones about a particular obstacle may be determined based on the potential effects of a collision of machine 12 with that obstacle. Some potential effects of a collision of machine 12 with an obstacle may include, for example, a likelihood and/or degree of damage to machine 12 and the obstacle, a potential cost of repairing that damage, a likelihood and/or degree of personal injury, a likelihood and cost of losses in productivity, and a subjective determination of nuisance of a collision between machine 12 and the obstacle.

It is contemplated that each stopping e-fence zone 32 may be generally bound by an avoidance e-fence zone 30, and that each avoidance e-fence zone 30 may be generally bound by a warning e-fence zone 28. Thus, if an obstacle has only one associated e-fence zone, that e-fence zone may be a warning e-fence zone 28. Similarly, if an obstacle has two associated e-fence zones, those e-fence zones may be an avoidance e-fence zone 30 bound by a warning e-fence zone 28. Further, if an obstacle has three associated e-fence zones, those e-fence zones may be a stopping e-fence zone 32 bound by an avoidance e-fence zone 30, further bound by a warning e-fence zone 28. It is contemplated that e-fence zones 28, 30, 32 may intersect or overlap one another, and that one e-fence zone may take precedence over another. For example, if two or more e-fence zones overlap, the overlapping region may be regarded as being part of the e-fence zone that represents the highest criticality.

The size of each artificial e-fence and the e-fence zones thereof may be at least partially determined by the criticality described above. For example, because the degree of damage to machine 12 and/or personal injury caused by a cliff may be greater than that caused by a pothole, the artificial e-fence about the cliff may be larger relative to the size of the artificial e-fence about the pothole. This may allow machine 12 to stop and/or alter its course at a greater distance from the cliff than the pothole. Similarly, the shape of the artificial e-fence about the cliff may be such that each point on the boundary of the artificial e-fence is located a minimum distance from the nearest point of the cliff, while the artificial e-fence about the pothole may simply be a circle approximating the shape of the pothole.

The size of each artificial e-fence and the e-fence zones thereof may additionally or alternatively be partially determined by characteristics of the obstacle they bound. That is, the shape of the artificial e-fence associated with a particular obstacle may be influenced by a type, size, and shape of the obstacle. For example, because a building may be more clearly visible than a fire hydrant, and thus less likely to be the object of a collision with machine 12, the artificial e-fence about the fire hydrant may be larger than the artificial e-fence zone about the building. In another example, the shape of the artificial e-fence zone about a pothole may be a circle corresponding to a substantially circular footprint of the pothole, while the shape of the artificial e-fence zone about the building may be a rectangle corresponding to a rectangular footprint of the building.

It is contemplated that some obstacles (particularly machine 12 and vehicle 24) may also include other e-fence-influencing characteristics such as, for example, a load, position, direction, velocity, and acceleration. For example, as illustrated in FIG. 1, the shape of the artificial e-fence about machine 12 and vehicle 24 may be skewed to be larger in directions that machine 12 and vehicle 24 may be likely to travel (i.e. heading and trajectory), and may be extended farther away from machine 12 and vehicle 24 as the velocities thereof increase.

It is also contemplated that the shape and/or size of the artificial e-fence about a particular obstacle may also be influenced by other factors such as, for example, a topography of worksite 10, a current weather condition, a time of day, an amount of visibility, and a proximity of the obstacle to other obstacles. For example, central control system 26 may be operable to receive the current weather condition at worksite 10. If it is snowing at worksite 10, central control system 26 may increase the size of the artificial e-fence about a cliff at worksite 10 to allow machine 12 more distance to change its direction, velocity, and/or acceleration before reaching the cliff in a snowy condition. In another example, central control system 26 may be operable to monitor the time of day, and increase the size of the artificial e-fence about the cliff at night, when the cliff may be less visible to an operator of machine 12. Further, central control system 26 may be operable to detect the level of visibility at an obstacle, as influenced by weather conditions (e.g., fog) and lighting levels. As the level of visibility about the cliff decreases, central control system 26 may increase the size of the artificial e-fence about the cliff. In yet another example, central control system 26 may increase the size of two or more artificial e-fences that substantially overlap. That is, if a fire hydrant at worksite 10 and a building at worksite 10 are close enough in proximity to one another that their artificial e-fences intersect, central control system 26 may alter the size and/or shape of their artificial e-fences to better protect them both from a collision with machine 12. Alternatively, in this case, central control system 26 may combine their artificial e-fences.

It should be appreciated that some characteristics of each obstacle may be fixed while others may change over time. For example, the position of a fire hydrant may be fixed, while the position of a vehicle may be transient. As such, the characteristics of each obstacle and machine 12 may either be predetermined and fixed, or continuously monitored and/or dynamically updated by central control system 26. For example, some obstacles may be surveyed for their geographical location, size, shape, and criticality. This surveyed data may then be delivered to central control system 26. It is contemplated that some obstacle characteristics may be visually observed by an operator of worksite 10, or measured by machine 12 as it traverses worksite 10, if desired. It is further contemplated that obstacles may be “tagged” with a remote identifier such as, for example, an RFID tag to transmit the obstacles' locations and characteristics. That is, some obstacles may be connected to communicate remotely with components of central control system 26 to deliver information about, for example, the type, size, shape, load, position, direction, velocity, and acceleration of the obstacle such that central control system 26 may utilize any of this data to define an appropriate number, size, and shape of e-fence zones 28, 30, 32. It is contemplated that a combination of surveying and real-time monitoring may be used to define e-fence zones 28, 30, 32, if desired. It is also contemplated that the number, size, and shape of e-fence zones 28, 30, 32 may alternatively or additionally be manually set by an operator of central control system 26. It is further contemplated that central control system 26 may alternatively or additionally determine some obstacle characteristics based on received characteristics. For example, the direction of vehicle 24 may be calculated by central control system 26 based on received changes in the position of vehicle 24.

Central control system 26 may represent some characteristics of the obstacles on the terrain map. For example, central control system 26 may represent each obstacle on the terrain map according to its position in site coordinates. Further, central control system 26 may represent some characteristics on the terrain map using, among other things, shapes, symbols, color codes, or any other means known in the art. For example, central control system 26 may represent the criticality of an e-fence zone by color coding a corresponding region of the terrain map. That is, warning e-fence zone 28 may be represented by a yellow zone on the terrain map, while avoidance e-fence zone 30 may be represented by an orange zone of the terrain map, and stopping e-fence zone 32 may be represented by a red zone on the terrain map.

It is contemplated that the shape of each artificial e-fence and the e-fence zones thereof may further be influenced by characteristics of mobile machines operating in the vicinity thereof. For example, the shape of the artificial e-fence about a particular obstacle may be influenced by a type, size, shape, load, position, direction, velocity, and/or acceleration of machine 12 that is operating near the particular obstacle. It should be noted that machine 12 may embody any number of mobile machines and that a distinct artificial e-fence may be defined about each obstacle relative to each mobile machine. In an exemplary scenario, a first mobile machine may embody a truck with a relatively high speed and a load, while a second mobile machine may embody a tractor with a speed and a load less than the speed and load of the truck. The truck may approach hazardous area 18 from a southern direction, while the tractor approaches hazardous area 18 from a northern direction. Central control system 26 may generate a first set of e-fence zones 28, 30, 32 associated with the truck and a second set of e-fence zones 28, 30, 32 associated with the tractor. The shape of the first set of e-fence zones 28, 30, 32 may be substantially different from the second set of e-fence zones 28, 30, 32, based on the characteristics of the truck and tractor, respectively. For example, because the truck may approach hazardous area 18 from a direction different from that of the tractor, the first set of e-fence zones 28, 30, 32 may be larger on the side of the truck's approach while the second set of e-fence zones 28, 30, 32 may be larger on the side of the tractor's approach. Further, because the truck may be heavier and traveling faster than the tractor, the first set of e-fence zones 28, 30, 32 may generally be larger than the second set of e-fence zones 28, 30, 32. Thus, after entering e-fence zones 28, 30, 32, the truck may have a greater distance in which to slow, stop, and/or change direction than that required by the tractor.

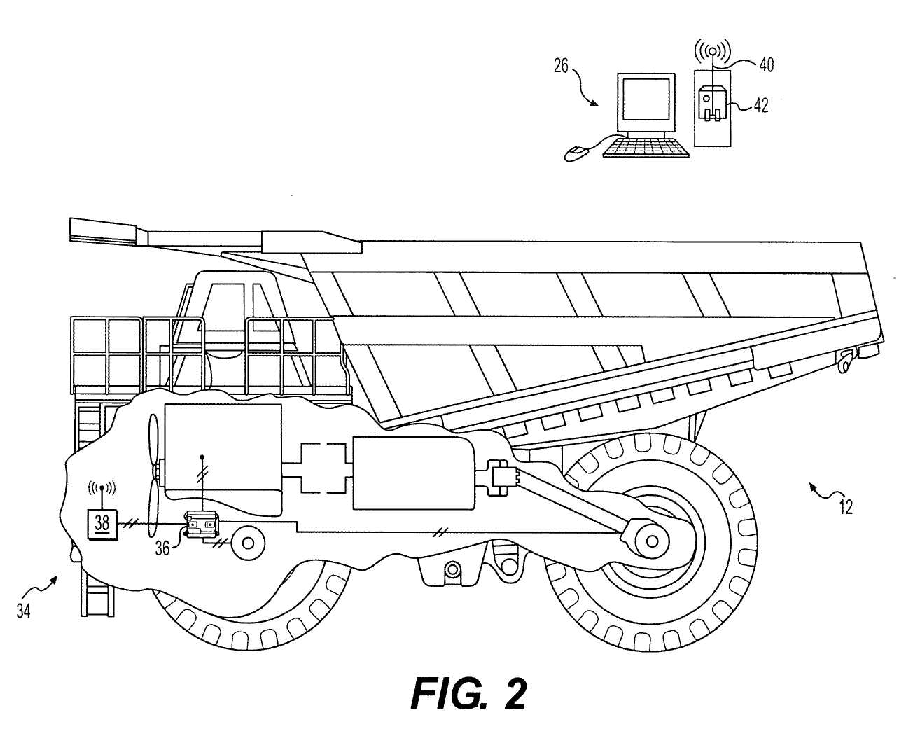

In order to remotely monitor the changing characteristics of machine 12, central control system 26 may be connected to communicate remotely with machine 12 to receive information about its type, size, shape, load, position, direction, velocity, and acceleration. As central control system 26 receives characteristic updates from machine 12, it may alter the artificial e-fences. More specifically, central control system 26 may include an algorithm in its memory operable to use the received characteristics of machine 12 to determine the shape of each artificial e-fence. For example, central control system 26 may skew the shape of e-fence zones 28, 30, 32 toward the position of machine 12, with the amount of skew being dependent on the other characteristics of machine 12. This may approximate a probable path of approach for machine 12 toward each obstacle. As the position of machine 12 changes, central control system 26 may alter the shape of e-fence zones 28, 30, 32 to skew toward the new position of machine 12. In another example, central control system 26 may increase the size of e-fence zones 28, 30, 32 as the velocity of machine 12 increases, thus allowing machine 12 more time to slow, turn, and/or stop to avoid a collision with an obstacle. In order to facilitate remote communication with central control system 26, machine 12 may include a remote communication system 34 (shown in FIG. 2) to sense and/or store the characteristics thereof and wirelessly transmit this data to central control system 26.

Remote communication system 34 may monitor the characteristics of machine 12 described above. For example, remote communication system 34 may monitor the load, position, direction, and velocity of machine 12. It is contemplated that remote communication system 34 may additionally or alternatively monitor any other characteristics of machine 12, if desired. It is contemplated that remote communication system 34 may similarly be included at or within an obstacle of worksite 10 to monitor the characteristics thereof. FIG. 2 illustrates an exemplary embodiment of remote communication system 34, as included in machine 12. While the following description of remote communication system 34 is directed to machine 12, it is contemplated that similar embodiments may be employed for use with any of the obstacles at worksite 10.

Remote communication system 34 may include a controller 36, a transceiver 38, and a plurality of sensors (not shown) such as, for example, a load sensor, a position sensor, a direction sensor, and a velocity sensor. It is contemplated that remote communication system 34 may alternatively or additionally include other components such as, for example, an acceleration sensor, or any other component known in the art.

Controller 36 may embody a single microprocessor or multiple microprocessors that include a means for monitoring characteristics of machine 12 by receiving signals from the sensors of remote communication system 34. For example, controller 36 may include a memory, a secondary storage device, a clock, and a processor, such as a central processing unit or any other means for accomplishing a task consistent with the present disclosure. Numerous commercially available microprocessors can be configured to perform the functions of controller 36. It should be appreciated that controller 36 could readily embody a computer system capable of controlling numerous other functions. Various other known circuits may be associated with controller 36, including signal-conditioning circuitry, communication circuitry, and other appropriate circuitry. It should also be appreciated that controller 36 may include one or more of an application-specific integrated circuit (ASIC), a field-programmable gate array (FPGA), a computer system, and a logic circuit configured to allow controller 36 to function in accordance with the present disclosure. Thus, the memory of controller 36 may embody, for example, the flash memory of an ASIC, flip-flops in an FPGA, the random access memory of a computer system, or a memory circuit contained in a logic circuit. Controller 36 may be further communicatively coupled with an external computer system, instead of or in addition to including a computer system.

Controller 36 may receive signals from the sensors of remote communication system 34, and deliver the signals to transceiver 38. To that end, controller 36 may be communicatively coupled with the sensors and transceiver 38. Controller 36 may additionally receive signals such as command signals indicative of a desired direction, velocity, acceleration, and/or braking of machine 12, and autonomously control machine 12 to follow those commands. To that end, controller 36 may further be communicatively coupled with the power source of machine 12, the braking element of machine 12, and the direction control of machine 12. Further, controller 36 may be communicatively coupled with a user interface in the operator cabin of machine 12 to deliver information to an operator of machine 12. For example, controller 36 may be communicatively coupled with a monitor to display the terrain map of worksite 10, and any number of warning lights or buzzers to alert the operator to a condition such as, for example, machine 12 entering any one of e-fence zone 28, 30, 32.

Transceiver 38 may generally transmit signals indicative of the characteristics of machine 12. That is, transceiver 38 may receive signals indicative of a characteristic of machine 12 from controller 36, and wirelessly broadcast these signals. To that end, transceiver 38 may embody any type of wireless communication device capable of sending and receiving signals known in the art. It is contemplated that transceiver 38 may alternatively embody a separate transmitter and receiver, if desired. It is also contemplated that transceiver 38 may additionally receive signals such as command signals indicative of a desired direction, velocity, acceleration, and/or braking of machine 12, and deliver those signals to controller 36. Further, if transceiver 38 is used only to send signals from an associated obstacle, it is contemplated that transceiver 38 may embody a transmitter without a receiver, if desired.

The signals from the sensors of remote communication system 34 may be delivered to transceiver 38 directly or via controller 36. Transceiver 38 may then broadcast the signals wirelessly. It is contemplated that the signals from the sensors may be broadcast separately or jointly. It is further contemplated that the broadcast may be received by central control system 26.

The components of central control system 26 may receive and monitor the characteristics of machine 12, and transmit alerts and/or control commands to machine 12 based on its position relative to the artificial e-fences. Central control system 26 may include, for example, a transceiver 40 and a controller 42.

Transceiver 40 may generally receive signals indicative of the characteristics of the obstacles at worksite 10 and machine 12. That is, transceiver 40 may wirelessly receive signals indicative of the characteristics of the obstacles at worksite 10 and machine 12, and deliver the received signals to controller 42. To that end, transceiver 40 may embody any type of wireless communication device capable of sending and receiving signals known in the art. It is contemplated that transceiver 40 may alternatively embody a separate transmitter and receiver, if desired. Transceiver 40 may additionally direct control signals to machine 12, such as command signals indicative of a desired direction, velocity, acceleration, and/or braking of machine 12, and transmit those signals to machine 12. Although not shown, it is contemplated that transceiver 40 may be in wireless communication with any number of wireless base stations to relay signals to and from transceiver 40. For example, a topography of worksite 10 may block signals from being directly transmitted between transceiver 40 and remote communication system 34. As such, a system of wireless base stations may be included at worksite 10 to relay signals around, over, under, or through the signal-blocking topographical features of worksite 10.

Controller 42 may embody a single microprocessor or multiple microprocessors that include a means for receiving and monitoring data, generating a terrain map of worksite 10 including obstacles thereon, generating artificial e-fence zones about those obstacles, and generating and transmitting alerts and/or control commands to a mobile machine based on its proximity to those obstacles. For example, controller 42 may include a memory, a secondary storage device, a clock, and a processor, such as a central processing unit or any other means for accomplishing a task consistent with the present disclosure. Numerous commercially available microprocessors can be configured to perform the functions of controller 42. It should be appreciated that controller 42 could readily embody a computer system capable of controlling numerous other functions. Various other known circuits may be associated with controller 42, including signal-conditioning circuitry, communication circuitry, and other appropriate circuitry. It should also be appreciated that controller 42 may include one or more of an application-specific integrated circuit (ASIC), a field-programmable gate array (FPGA), a computer system, and a logic circuit configured to allow controller 42 to function in accordance with the present disclosure. Thus, the memory of controller 42 may embody, for example, the flash memory of an ASIC, flip-flops in an FPGA, the random access memory of a computer system, or a memory circuit contained in a logic circuit. Controller 42 may be further communicatively coupled with an external computer system, instead of or in addition to including a computer system.

Controller 42 may determine whether machine 12 has entered an e-fence zone (i.e., crossed an artificial e-fence), and deliver one or more signals to machine 12 based on which of the e-fence zones 28, 30, 32 it has entered. More specifically, controller 42 may generate alerts and/or control commands for delivery to machine 12 via transceiver 40, and the type of alert may be at least partially determined by the type of e-fence zone the vehicle has entered. For example, controller 42 may deliver a low-level alert when machine 12 has entered warning e-fence zone 28. In another example, controller 42 may deliver a mid-level alert to machine 12 when machine 12 has entered avoidance e-fence zone 30, and a high-level alert when machine 12 has entered stopping e-fence zone 32. Similarly, the type of control command issued by controller 42 to machine 12 may be at least partially determined by the type of e-fence zone machine 12 has entered. More specifically, the command signals may include such commands as velocity limit commands, acceleration limit commands, braking commands, and direction commands. That is, controller 42 may generate control commands to limit a maximum velocity or acceleration of machine 12, to cause machine 12 to slow down or come to a full stop, or to redirect machine 12 along an avoidance trajectory. In one example, when machine 12 enters warning e-fence zone 28 for natural obstacle 14, controller 42 may generate a command signal to limit a maximum velocity and/or change the direction of machine 12. In another example, when machine 12 enters avoidance e-fence zone 30 for natural obstacle 14, controller 42 may generate a command signal to slow machine 12 and/or change the direction of machine 12. In yet another example, if machine 12 enters stopping e-fence zone 32 for natural obstacle 14, controller 42 may generate a command signal to fully stop the motion of machine 12.

It is contemplated that the type of control signal sent by controller 42 may also be at least partially determined by a characteristic of machine 12 (e.g., whether it is manned or autonomous). For example, if machine 12 is manned and enters avoidance e-fence zone 30, controller 42 may deliver a control command to limit a maximum velocity of machine 12. Alternatively, if machine 12 is autonomous and enters avoidance e-fence zone 30, controller 42 may deliver a control command to reduce the velocity of machine 12 while also changing the trajectory of machine 12.

The signals generated by controller 42 may be transmitted to remote communication system 34 via transceiver 40. That is, transceiver 38 of remote communications system 34 may receive the signals generated by controller 42, and deliver the signals to controller 36 of remote communications system 34. Controller 36 may then process the signals. For example, if an alert signal is received, controller 36 may activate the warning lights and/or buzzers of machine 12, as indicated by the alert signal. Further, if a control command is received, controller 36 may alter operation of the power source, braking element, and/or direction control of machine 12, as indicated by the control command.

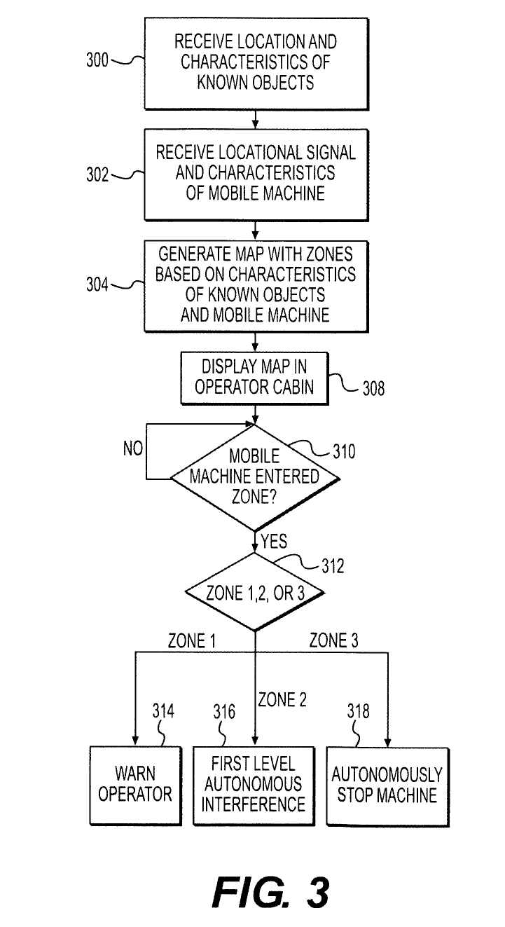

FIG. 3 provides a flowchart depicting an exemplary operation of central control system 26 and remote communication system 34 relative to machine 12. Operation of central control system 26 and remote communication system 34 will be described with reference to FIG. 3 in the following section.

### INDUSTRIAL APPLICABILITY

The disclosed mapping and machine control system finds potential application at a worksite where it is desirous to map objects at the worksite and remotely control vehicles to avoid collisions with the mapped objects. The disclosed mapping and machine control system may be particularly advantageous in a worksite having a number of stationary obstacles and multiple mobile machines. The operation of central control system 26 and remote communication system 34 will now be explained.

Referring to FIG. 1, machine 12 may traverse worksite 10 to perform any operation consistent with the work operation of worksite 10. As discussed above, worksite 10 may include a number of obstacles. As machine 12 traverses worksite 10, it may come near to or even collide with the obstacles at worksite 10. A collision between machine 12 and an obstacle at worksite 10 may have any number of undesirable effects including, for example, damage to machine 12 or the obstacle, added expenses, personal injury, and a loss in productivity. In order to minimize or avoid collisions of machine 10 with the obstacles at worksite 10, central control system 26 and remote communication system 34 may cooperate to map worksite 10 and alert, control, or partially control machine 12. FIG. 3 illustrates an exemplary operation performed by central control system 26 and remote communication system 34.

In order to create a terrain map of worksite 10, controller 42 of central control system 26 may generally receive data describing the terrain at worksite 10, the obstacles at worksite 10, and machine 12. Controller 42 may first receive data describing the terrain of worksite 10, and the locations and characteristics of the obstacles at worksite 10 (Step 300). For example, the elevations of various points at worksite 10 may be measured by a surveyor. This data may then be input manually to controller 42 to provide a relief to the terrain map. Further, the surveyor may record a position, size, and approximate shape of, for example, a fire hydrant at worksite 10, and enter this data to controller 42 to provide the fire hydrant as one of the obstacles at worksite 10. This process may be repeated for each obstacle at worksite 10. Controller 42 may generally use the received data to represent the obstacles at worksite 10.

Controller 42 may also receive signals indicative of the position and characteristics of machine 12 (Step 302). That is, as the position and characteristics of machine 12 change, remote communication system 34 may communicate signals indicative of these changes to central control system 26. More specifically, as the load, position, direction, and velocity of machine 12 change, the load sensor, position sensor, direction sensor, and velocity sensor of remote communication system 34 may deliver respective signals to controller 36 of remote communication system 34. These signals may then be delivered from controller 36 to central control system 26. Further, controller 42 of central control system 26 may provide updates to the terrain map of worksite 10 corresponding to the updated data as it is received from remote communication system 34.

Controller 42 may then generate the terrain map of worksite 10 based on the terrain data, the locations and characteristics of the obstacles at worksite 10 and machine 12, and related e-fence zones 28, 30, 32 (Step 304). That is, the terrain map may represent the work surface of worksite 10, the obstacles at worksite 10, and machine 12 according to their positions. Controller 42 may use the algorithms in its memory to associate e-fence zones 28, 30, 32 with each obstacle and machine 10. More specifically, controller 42 may associate one set of e-fence zones 28, 30, 32 with each obstacle relative to machine 12 to help anticipate and prevent potential collisions between machine 12 and the obstacles. For example, controller 42 may use the received position, size, and approximate shape of the fire hydrant at worksite 10, in conjunction with the position, speed, and trajectory of machine 12 to define an artificial e-fence about the fire hydrant. The artificial e-fence may be skewed toward the most likely approach trajectory of machine 12, and may include a number of e-fence zones 28, 30, 32 determined by the criticality of a collision of machine 12 with the fire hydrant. More specifically, because the fire hydrant may be irreparably damaged by a collision with machine 12, controller 42 may define a warning e-fence zone 28, an avoidance e-fence zone 30, and a stopping e-fence zone 32 about the fire hydrant.

With regard to a manned embodiment of machine 12, central control system 26 and remote communications system 34 may cooperate to display the terrain map in the operator cabin of machine 12 (Step 308). For example, controller 42 may deliver data representing the terrain map to transceiver 40 for delivery to remote communication system 34. Controller 36 of remote communication system 34 may then display the terrain map on the monitor of machine 12. As the terrain map is updated by controller 42, the updated terrain map may be transmitted to machine 12. Thus, the displayed terrain map may be updated in real-time. The displayed terrain map may show the obstacles at worksite 10 at their relative positions, along with e-fence zones 28, 30, 32, as defined by controller 42 relative to machine 12. The displayed terrain map may also show machine 12 at its relative position on the terrain map. It is contemplated that the displayed terrain map may show all of the terrain map (e.g., all of worksite 10), or only a portion of the terrain map (e.g., only a portion of worksite 10). For example, the displayed terrain map show a portion of worksite 10 nearest machine 12.

Controller 42 may then detect whether machine 12 has entered any of e-fence zones 28, 30, 32 (Step 310). Controller 42 may receive the position of machine 12, and compare the position with e-fence zones 28, 30, 32, accordingly. Further, controller 42 may use the received position updates to determine whether machine 12 is positioned within any of e-fence zones 28, 30, 32 (i.e., machine 12 has crossed an artificial e-fence or boundary of the zones thereof).

Controller 42 may generate one or more signals in response to machine 12 entering an e-fence zone 28, 30, 32, and the signals may be determined based on the type of e-fence zone 28, 30, 32 machine 12 has entered. As such, controller 42 may determine which type of e-fence zone 28, 30, 32 machine 12 has entered (Step 312).

For example, when machine 12 enters warning e-fence zone 28, controller 42 may generate a signal to warn the operator of machine 12 (Step 314). More specifically, controller 42 may generate a warning signal instructing, for example, the warning light of machine 12 to turn on, and send this signal to machine 12. Controller 36 of remote communication system 34 may then evaluate the instructions of the signal and turn on the warning light of machine 12. It should be appreciated that the warning signal generated by controller 42 may include any type of instruction for machine 12. For example, the warning signal may alternatively or additionally include instructions to sound a buzzer of machine 12.

When machine 12 enters avoidance e-fence zone 30 for a given obstacle, controller 42 may generate a signal to autonomously modify operation of machine 12 (Step 316). For example, controller 42 may generate a signal including control commands to limit the speed or acceleration of machine 12, and/or to redirect machine 12 away from the obstacle. In a more specific example, controller 42 may generate an avoidance signal instructing, for example, the power output of the power source of machine 12 to remain below a threshold, and transmit the signal to remote communication system 34. Controller 36 may then evaluate the instructions of the signal and limit the power output of the power source of machine 12 to remain below the threshold.

When machine 12 enters stopping e-fence zone 32 for a given obstacle, controller 42 may generate a signal to autonomously stop all motion of machine 12 (Step 318). For example, controller 42 may generate a signal including control commands to stop machine 12. More specifically, controller 42 may generate a stopping signal instructing, for example, the braking element of machine 12 to bring machine 12 to a full stop, and transmit the signal to remote communication system 34. Controller 36 may then evaluate the instructions of the signal and manipulate the braking element of machine 12 to bring machine 12 to a full stop. The stopping signal may keep machine 12 from colliding with the obstacle.

It should be noted that while Steps 310-318 are described as being performed by controller 42 of central control system 26, these steps may alternatively be performed by controller 36 of remote communication system 34. More specifically, controller 36 may detect whether machine 12 has entered any of e-fence zones 28, 30, 32, determine which type of e-fence zone 28, 30, 32 machine 12 has entered, and generate signals (including warnings and/or control commands) in response to machine 12 entering an e-fence zone 28, 30, 32.

It should also be noted that the above steps may be different for an autonomously controlled embodiment of machine 12. In particular, Step 308 may be omitted since machine 12, in this embodiment, may have no operator. Further, the collision avoidance strategy of Step 314 may be changed or even omitted, if desired. For example, rather than delivering a warning to machine 12, controller 42 may alternatively evaluate the trajectory of machine 12.

The mapping and machine control system of the present disclosure may minimize the likelihood of collisions of a mobile machine with other objects at a worksite, while minimizing the cost of its implementation. That is, because the system of the present disclosure may require only one central control system, each mobile machine at the worksite may be equipped only with a remote communication system, which may be less expensive than the central control system, and easily installed in a mobile machine. Thus, the cost of the central control system may be incurred only once, and the cost of each mobile machine may increase only slightly.

Further, because the mapping and machine control system of the present disclosure takes into account both characteristics of the mobile machines and the obstacles at the worksite, protection may be provided for every combination of mobile machine and obstacle. More specifically, because each avoidance e-fence may be defined to prevent a collision between a specific mobile machine and a specific obstacle, collisions between any mobile machine and any obstacle at worksite 10 may be prevented. Further, collisions between a first mobile machine and a second mobile machine may also be avoided.

It will be apparent to those skilled in the art that various modifications and variations can be made to the avoidance system of the present disclosure. Other embodiments will be apparent to those skilled in the art from consideration of the specification and practice of the avoidance system disclosed herein. It is intended that the specification and examples be considered as exemplary only, with a true scope being indicated by the following claims and their equivalents.

What is claimed is:

1. A machine control system, comprising:
a receiving module configured to receive a position and a characteristic of an object at a worksite;
a positioning device configured to determine a position of a mobile machine at the worksite; and
a controller in communication with the receiving module and the positioning device, the controller being configured to:
generate an electronic map of the worksite;
generate an electronic representation of the object on the electronic map based on the received position;
generate at least one boundary zone around the object based on the received characteristic; and
generate an electronic representation of the mobile machine on the electronic map based on the determined position.

2. The machine control system of claim 1, wherein the controller is further configured to
initiate a collision avoidance strategy in response to a mobile machine entering the at least one boundary zone.

3. The machine control system of claim 2, wherein:
the at least one boundary zone includes a plurality of boundary zones around the object; and
the collision avoidance strategy implements different steps based on which of the plurality of boundary zones the mobile machine enters.

4. The machine control system of claim 3, wherein a severity of the collision avoidance strategy initiated when the mobile machine enters a first of the plurality of boundary zones is less than a severity of the collision avoidance strategy initiated when the mobile machine enters a second of the plurality of boundary zones.

5. The machine control system of claim 4, wherein the collision avoidance strategy initiated when the mobile machine enters the first boundary zone includes providing a warning to an operator of the mobile machine.

6. The machine control system of claim 5, wherein the collision avoidance strategy initiated when the mobile machine enters the second boundary zone includes one of: autonomously slowing the mobile machine, autonomously limiting a maximum velocity of the mobile machine, autonomously limiting a maximum acceleration of the mobile machine, and autonomously changing a direction of the mobile machine.

7. The machine control system of claim 4, wherein:
the at least one boundary zone further includes a third boundary zone; and
the collision avoidance strategy initiated when the mobile machine enters the third boundary zone includes autonomously stopping the mobile machine.

8. The machine control system of claim 4, wherein the second boundary zone is positioned closer to the object than the first boundary zone.

9. The machine control system of claim 1, wherein the controller is further configured to
modify the at least one boundary zone based on the determined position of the mobile machine; and
modify the electronic map based on the determined position of the mobile machine.

10. The machine control system of claim 1, wherein the controller is further configured to:
determine a characteristic of the mobile machine; and
modify the at least one boundary zone based on the determined characteristic of the mobile machine.

11. The machine control system of claim 10, wherein:
the determined characteristic includes a speed of the mobile machine; and
a size of the at least one boundary zone changes based on the speed.

12. The machine control system of claim 10, wherein:
the determined characteristic includes a load of the mobile machine; and
a size of the at least one boundary zone changes based on the load.

13. The machine control system of claim 1, wherein the at least one boundary zone includes a plurality of boundary zones color coded according to a distance from the object.

14. The machine control system of claim 1, wherein the electronic map includes manually communicated data and autonomously communicated data.

15. The machine control system of claim 1, wherein the object is one of:
a road condition, a facility, a utility, and another mobile machine at the worksite.

16. A method of avoiding collisions of a mobile machine with other objects at a common worksite, comprising:
receiving a position and a characteristic of an object at a worksite;
receiving a position of a mobile machine at the worksite;
generating an electronic map of the worksite;
generating an electronic representation of the object on the electronic map based on the received position;
generating at least one boundary zone around the object based on the received characteristic; and
generating an electronic representation of the mobile machine on the electronic map based on the determined position.

17. The method of claim 16, further including:
initiating a collision avoidance strategy in response to the mobile machine entering the at least one boundary zone.

18. The method of claim 17, wherein:
the at least one boundary zone includes a plurality of boundary zones around the object; and
the collision avoidance strategy implements different steps based on which of the plurality of boundary zones the mobile machine enters.

19. The method of claim 18, wherein a severity of the collision avoidance strategy initiated when the mobile machine enters a first of the plurality of boundary zones is less than a severity of the collision avoidance strategy initiated when the mobile machine enters a second of the plurality of boundary zones.

20. The method of claim 19, wherein the collision avoidance strategy initiated when the mobile machine enters the first boundary zone includes generating a warning.

21. The method of claim 20, wherein the collision avoidance strategy initiated when the mobile machine enters the second boundary zone includes one of: slowing the mobile machine, limiting a maximum velocity of the mobile machine, limiting a maximum acceleration of the mobile machine, and changing a direction of the mobile machine.

22. The method of claim 19, wherein:
the at least one boundary zone further includes a third boundary zone around the object; and
the collision avoidance strategy initiated when the mobile machine enters the third boundary zone includes stopping the mobile machine.

23. The method of claim 16, further including:
determining a characteristic of the mobile machine; and
modifying the at least one boundary zone based on the determined characteristic of the mobile machine.

24. A machine control system, comprising:
a receiving module configured to receive a map of a worksite, the map having an electronic representation of an object at the worksite and at least one boundary zone positioned around the object; and
a controller in communication with the receiving module, the controller being configured to initiate a collision avoidance strategy in response to a mobile machine entering the at least one boundary zone.

25. A method of avoiding collisions of a mobile machine with other objects at a common worksite, comprising:
receiving a map of the worksite, the map having an electronic representation of an object at the worksite and at least one boundary zone positioned around the object; and
initiating a collision avoidance strategy in response to the mobile machine entering the at least one boundary zone.

26. A mobile machine, comprising:
a power source configured to generate a power output;
a traction device driven by the power output to propel the machine;
a braking element operable to slow the traction device; and
a machine control system, including:
a receiving module configured to receive a map of a worksite, the map having an electronic representation of an object at the worksite and a first, second, and third boundary zone positioned around the object; and
a controller in communication with the receiving module, the controller being configured to initiate a different collision avoidance strategy in response to which of the first, second, and third boundary zones have been entered by the mobile machine.
